(19) United States
(12) Patent Application Publication
(10) Pub. No.: US 2011/0317010 A1
(43) Pub. Date: Dec. 29, 2011

(54) SYSTEM AND METHOD FOR TRACKING A PERSON IN A PRE-DEFINED AREA

(75) Inventors: Karthikeyan Balaji DHANAPAL, Ramapuram Chennai (IN); Arun Agrahara SOMASUNDARA, Hassan Dist. (IN); Sagar Prakash JOGLEKAR, Bibwewadi Pune (IN); Aditya NARANG, New Delhi (IN); Sanjoy PAUL, Agara Bangalore (IN)

(73) Assignee: INFOSYS TECHNOLOGIES LIMITED, Bangalore (IN)

(21) Appl. No.: 12/895,027

(22) Filed: Sep. 30, 2010

(30) Foreign Application Priority Data
Jun. 24, 2010 (IN) 1782/CHE/2010

(51) Int. Cl. H04N 7/18; G06K 9/00

(52) U.S. Cl. 348/143; 382/103; 348/E07.085

(57) ABSTRACT

The invention provides a method, system and computer program product for tracking a person in a pre-defined area. The pre-defined area includes a plurality of imaging devices placed at respective pre-defined locations to capture images of the person. The system in conjunction with the plurality of imaging devices locates the person at the pre-defined area based on the captured images of the person.

### BACKGROUND

The present invention relates to tracking a person. More specifically, it relates to location tracking of the person in a pre-defined area.

With the growth of the surveillance technology, many technologies have been implemented to monitor goods, merchandise, and, most importantly, people. These technologies are constantly implemented in facilities, such as factories, shopping complexes, and amusement parks, to track the people. For example, one of the most common technologies used to monitor the people in a facility, such as a shopping complex, is a Radio Frequency Identification Device (RFID).

A typical RFID system in the facility includes various RFID readers located at one or more locations. Further, a person in the facility may be provided with an object tagged with an RFID. Thus, based on the object that the person carries, his/her movement is traced by the RFID readers. An example of implementation of the RFID system includes, a mobile trolley tagged with the RFID and a plurality of RFID readers installed at various sections in a shopping complex. Thus, when the RFID tagged trolley passes any RFID reader placed at a section of the shopping complex, the RFID reader immediately scans the RFID tagged with the trolley. Thereafter, it updates the present location of the trolley based on the section where the RFID tag is scanned.

However, RFID tags are prone to mechanical and environmental hazards because of being tagged externally, thus reducing their life. Therefore, the RFID tags have to be routinely changed which increases the maintenance cost. Also, the cost of maintenance varies with the size and environment of the facility.

The above mentioned limitations of the existing RFID system give rise to the need for a method, system, and computer program product that minimizes the limitations and provides a scalable and cost-efficient tracking system.

### SUMMARY

The invention provides a method, system and computer program product for tracking a person in a pre-defined area. A plurality of imaging device is located in the pre-defined area. Further, each of the plurality of imaging devices is located at a corresponding pre-defined location in the pre-defined area and interacts with the system. The system includes an image receiving module, an image processing module, and a location module. The image receiving module receives a first image of a lower portion of the person captured by a first imaging device located at a first location and a second image of the lower portion of the person captured by a second imaging device located at a second location. Thereafter, an image processing module recognizes the person captured in the second image by comparing the second image with the first image. Subsequently, the location module locates the recognized person based on the second location.

The method, system and computer program product described above have a number of advantages. The invention as described above provides a cost effective and an efficient method for tracking a person. Further, the system is adaptable to interact with multiple imaging devices and thus is capable of being implemented in large facilities, such as shopping complexes and factories. Further, in contrast to the typical RFID tag system, the invention is not prone to considerable mechanical wear and tear which reduces the maintenance costs significantly. Moreover, since the invention utilizes image comparison based on the image of the lower portion of the person, it maintains the anonymity of the person and thereby eliminates the privacy issues of people in a predefined area. The system also provides a platform to send information based on the present location of the identified person to a communication device of the person. Such functionality helps the person to remotely receive promotional messages of the products available at the location where the person is present. In addition to the above mentioned advantages, the system also performs a trend analysis of the movement of the person in the pre-defined area.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIG. 2 is a flowchart illustrating a method for tracking a person in a pre-defined area, in accordance with an embodiment of the invention;

FIG. 3 is a flowchart illustrating a method for processing a first image, in accordance with the embodiment of the invention;

FIG. 4a, FIG. 4b, and FIG. 4c represent a flowchart of a method for tracking the person in the pre-defined area, in accordance with the embodiment of the invention;

FIG. 5a and FIG. 5b represent a flowchart illustrating a method for tracking a person in a pre-defined area, in accordance with another embodiment of the invention;

FIG. 6a, FIG. 6b, and FIG. 6c represent a flowchart illustrating a method for tracking a person in a pre-defined area, in accordance with yet another embodiment of the invention;

FIG. 7 is a block diagram of a system for tracking a person in a pre-defined area, in accordance with an embodiment of the invention;

FIG. 8 is a block diagram of a system for tracking a person in a pre-defined area, in accordance with another embodiment of the invention; and

FIG. 9 is a block diagram of a system for tracking a person in a pre-defined area, in accordance with yet another embodiment of the invention.

### DETAILED DESCRIPTION OF THE DRAWINGS

The invention provides a method, system and computer program product for tracking a person in a pre-defined area. The pre-defined area includes a plurality of imaging devices placed at respective pre-defined locations to capture images of the person. The system in conjunction with the plurality of imaging devices locates the person at the pre-defined area based on the captured images of the person.

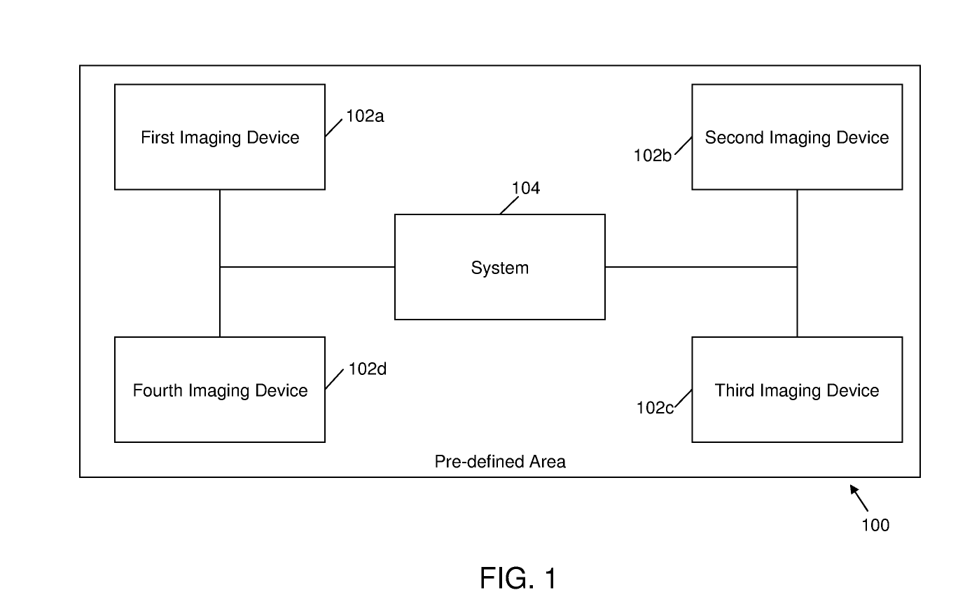

FIG. 1 illustrates a pre-defined area 100 in which various embodiments of the invention may be practiced. Pre-defined area 100 includes a system 104, a first imaging device 102a, a second imaging device 102b, a third imaging device 102c, and a fourth imaging device 102d, hereinafter, also referred to as a plurality of imaging devices 102. In various embodiments of the invention, plurality of imaging devices 102 interact with system 104 to track the person in pre-defined area 100. Plurality of imaging devices 102 are placed in pre-defined area 100 at various pre-defined locations to capture one or more images of the person.

Various examples of pre-defined area 100 include, but are not limited to, a shopping complex, an office premise, an amusement park, and a zoo. Further, examples of plurality of imaging devices 102 include, but are not limited to, a webcam, digital still cameras, and digital video cameras. It may be apparent to a person skilled in the art that pre-defined area 100, such as a shopping complex, may include various pre-defined locations, such as “grocery section”, “frozen foods section”, “wines and spirits section”, “toys section” and the like.

As mentioned earlier, each imaging device of plurality of imaging devices 102 is placed at a corresponding pre-defined location in pre-defined area 100. For example, an imaging device such as first imaging device 102a may be placed at a “frozen foods section” and second imaging device 102b may be placed at “wines and spirits section”. System 104 determines the present location of the person based on the images captured by first imaging device 102a and second imaging device 102b respectively.

To further elaborate the working of system 104 with the help of an example, a person may arrive at the “frozen food section” in the shopping complex. A first image of the person is captured by first imaging device 102a and is stored in a database. In various embodiments of the invention, the first image of the person may be defined as the primary image of the person, i.e., the first image of the person is an image captured for the first time in pre-defined area 100. Furthermore, the person may then move around the shopping complex and may arrive at the “wines and spirits section” in the shopping complex. Hence, a second image of the person is captured by second imaging device 102b placed at “wines and spirits section”. In various embodiments of the invention, the second image of the person is the subsequent image of the person that is captured in pre-defined area 100. The second image can be any image, such as third image and fourth image, subsequent to the first image of the person.

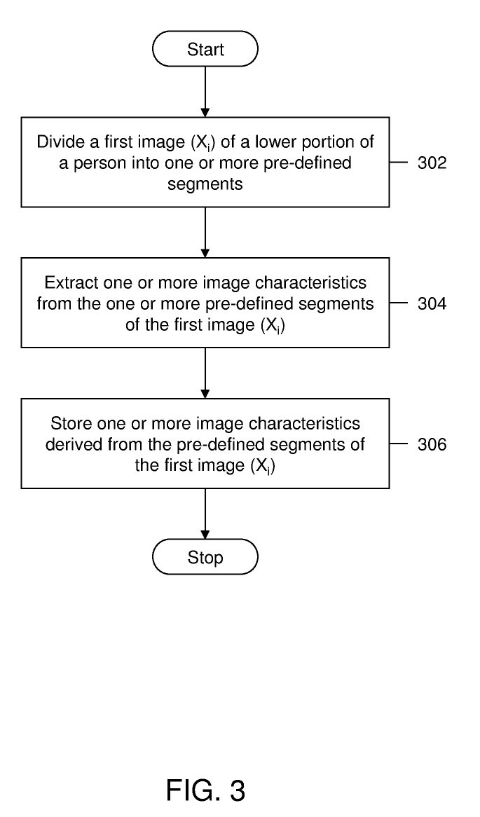

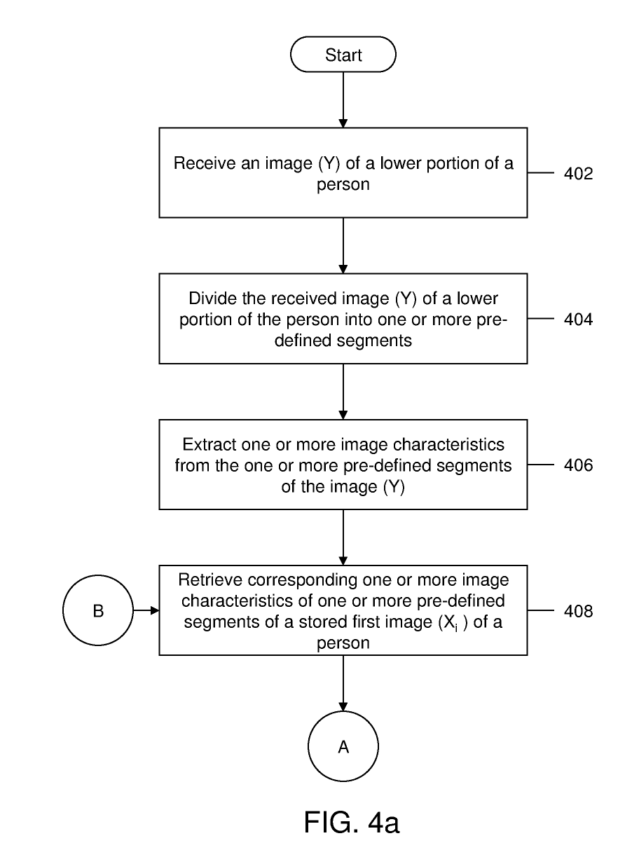

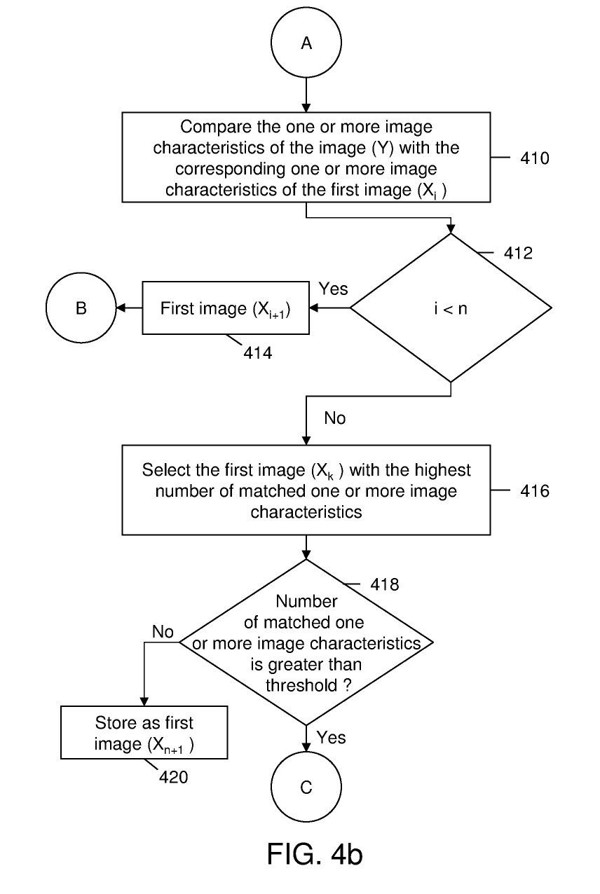

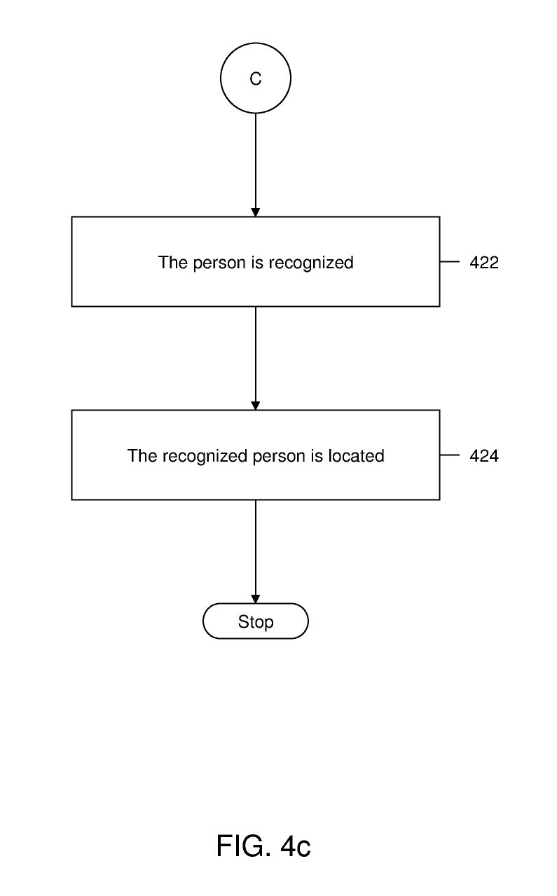

Thereafter, system 104 processes the second image and the first image to recognize the person captured at the second location. Subsequently, system 104 on the successful recognition of the person updates the location of the person according to the location of second imaging device 102b in the database. Following the current example, the present location of the person is updated as “wines and spirits section” in the shopping complex. Further, the methodology of comparison of the first image and the second image is elaborated in detail in conjunction with FIG. 3 and FIG. 4.

It would be appreciated by a person skilled in the art that the primary image and the subsequent image of the person can be captured by any imaging device of plurality of imaging devices 102. Further, the order in which an imaging device captures the images of the person defines the chronology of the images of the person.

In another embodiment of the invention system 104 may be contained in each of first imaging device 102a, second imaging device 102b, third imaging device 102c, fourth imaging device 102d and so forth.

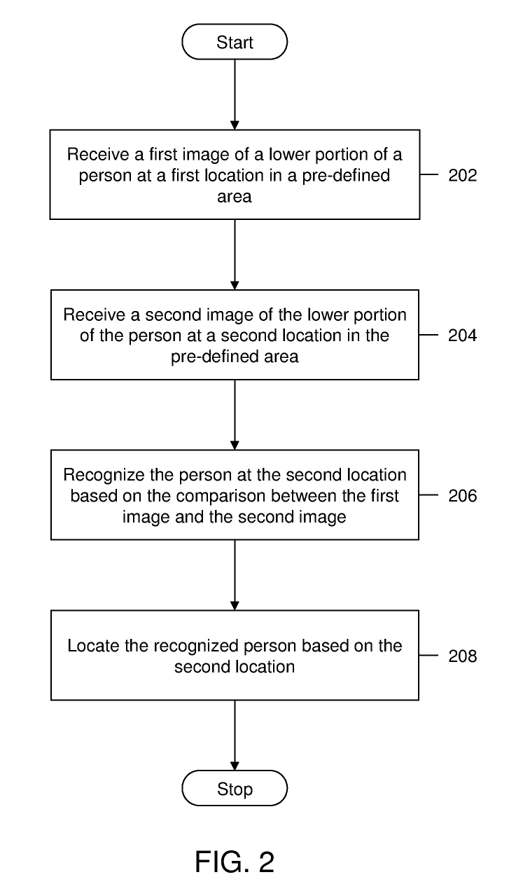

FIG. 2 is a flowchart illustrating a method for tracking a person in a pre-defined area, such as pre-defined area 100, in accordance with an embodiment of the invention.

The method for tracking the person in the pre-defined area, such as shopping complex, is implemented with a system, such as system 104, in conjunction with a plurality of imaging devices, such as plurality of imaging devices 102 (as described in FIG. 1). The present embodiment of the invention is implemented using a first imaging device, such as first imaging device 102a; a second imaging device, such as second imaging device 102b; and the system.

At 202, a first image of a lower portion of the person is received. In an embodiment, the first image, i.e., the primary image of the person is captured by the first imaging device. The first imaging device is placed at a pre-defined location, such as “frozen foods section”, in the shopping complex. Further, the lower portion of the person relates to the portion below the waist of the person.

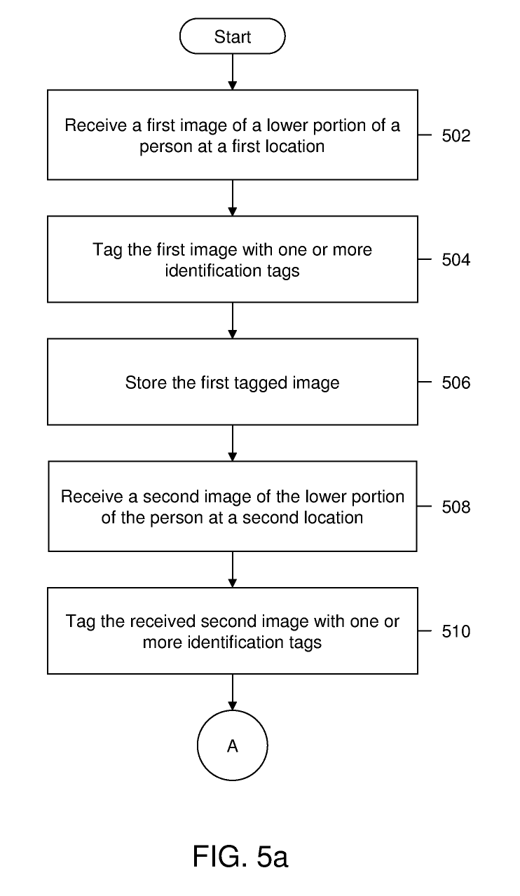

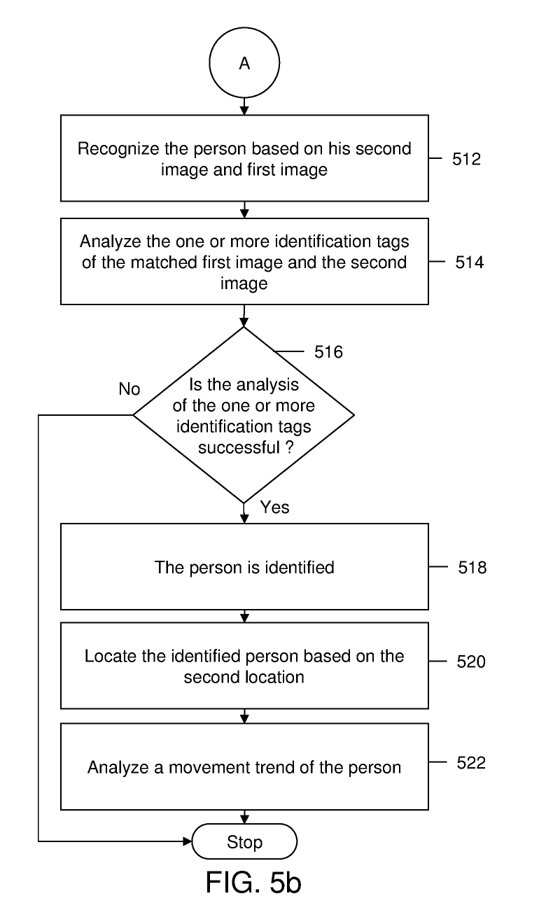

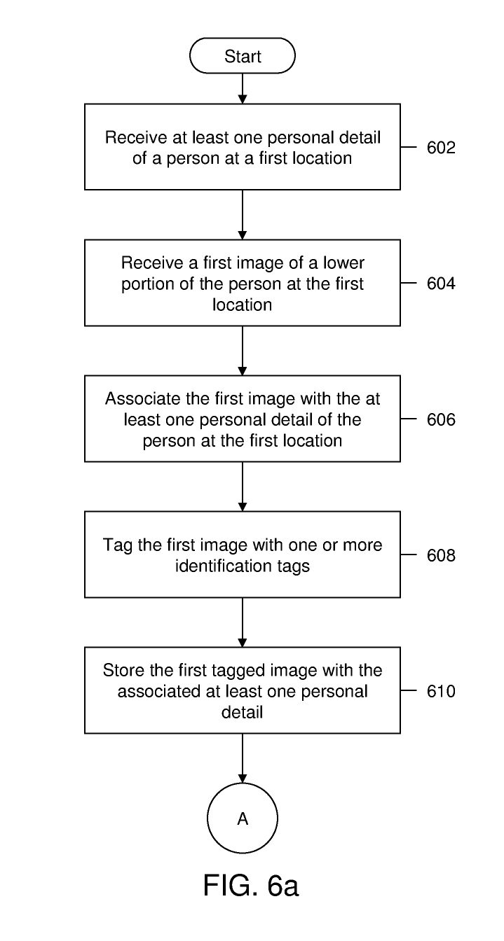

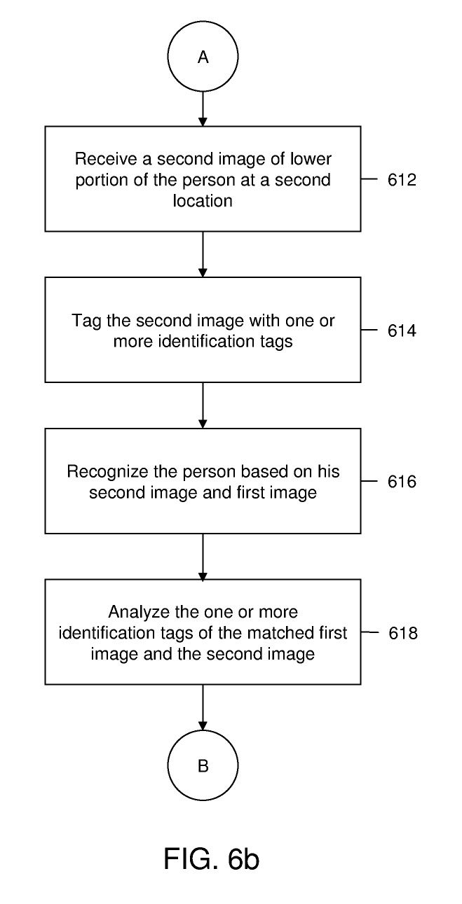

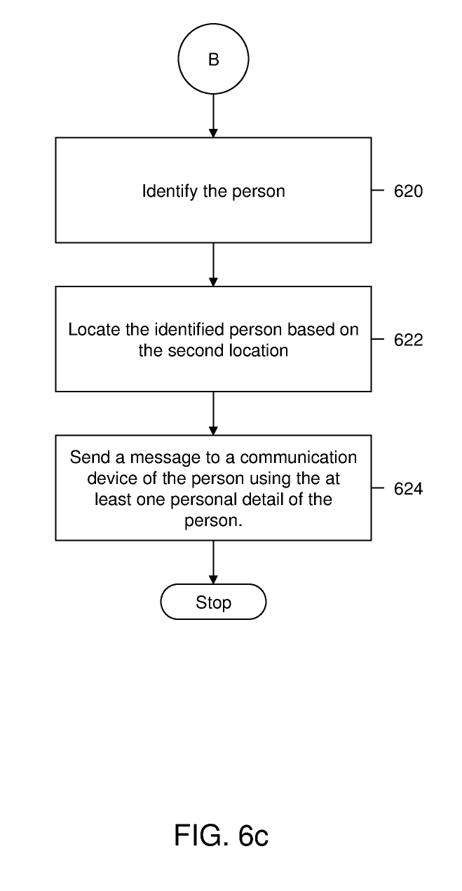

In an embodiment of the invention, the first image of the person is received by the first imaging device that is placed at a fixed entry point in the pre-defined area. This has been further elaborated in FIG. 6. In another embodiment of the invention the first image of the person is received by any imaging device placed in the pre-defined area as further described in FIG. 4 & FIG. 5. Further, it may be apparent to a person skilled in the art that in such scenario the imaging device that captures the first image may be then referred to as the first imaging device.

At 204, a second image of the lower portion of the person is received. The second image of the person is captured by the second imaging device. The second imaging device is placed at a second location in the shopping complex. As explained earlier, the second image of the person refers to any image subsequent to the first image of the person. In continuation to the above example, the second imaging device may be placed at the “wines and spirits section” in the shopping complex.

At 206, the person captured in the second image is recognized based on the first image and the second image. In various embodiments of the invention, the person is recognized by matching/comparing the first image and the second image. Further, the comparison is performed utilizing one or more image processing algorithms. Various image processing algorithms may include, but are not limited to, Speeded Up Robust Features (SURF), a SUM of Absolute Differences (SAD), and color processing algorithms. Further, the methodology of comparing the second image with the first image by utilizing the image processing algorithms is further explained in conjunction with FIG. 3 and FIG. 4.

Thereafter, at 208, the recognized person is located based on the pre-defined location of the second imaging device. For example, as described earlier, the second image of the person was captured by the second imaging device located at the “wines and spirits section” of the shopping complex. Thus, the current location of the person is determined as “wines and spirits section”, which is the pre-defined location of the second imaging device.

FIG. 3 is a flowchart illustrating a method for processing a first image, in accordance with the embodiment of the invention. In various embodiments of the invention, the processed first image corresponding to each person in a pre-defined area is stored in a database. For clarity, the first image is denoted as a variable Xᵢ, where i ranges from 1 to n, and n represents the current total number of images stored in the database. In other words, ‘n’ is the total number of people corresponding to whom the first images are stored in the database. Further, processing of the first image Xᵢ is explained in detail below.

At 302, the received first image Xᵢ of the lower portion of the person is divided into one or more pre-defined segments. For example, the pre-defined segments of the first image Xᵢ (lower portion) may be a segment representing a shoe area and a segment representing a non-shoe area, such as trousers. In an embodiment of the invention, prior to dividing the first image Xᵢ of the person into the pre-defined segments, the lower portion of the image may be separated from the background. A typical example of the background may be a wall behind the person. Thus, it may be apparent to a person skilled in the art that the first image that is divided in to the pre-defined segments refers to the foreground of the first image. Various Background (BG) modeling algorithms known in the art may be used to differentiate the foreground and background of the first image.

Thereafter, at 304, one or more image characteristics are extracted from the pre-defined segments of the first image Xᵢ. In an embodiment of the invention, an image characteristic is defined as features associated with a pre-defined image segment. For example, streaks or lines present at a particular position on the shoe segment. In another embodiment of the invention, the image characteristic may be defined as color of the non-shoe segment. The image characteristics thus extracted serve as the unique identification points corresponding to the person, thereby facilitating matching of any subsequent image of the person.

It may be apparent to any person skilled in the art that the image characteristics from the pre-defined segments may be extracted using one or more image processing algorithms. In an embodiment of the invention, the image processing algorithm used is the monolithic SURF algorithm. The methodology of the algorithm implemented for matching/comparison is further described in conjunction with FIG. 4. Subsequently, the extracted image characteristics corresponding to the pre-defined segments at 304 are stored at 306. It may be apparent to any person skilled in the art that the image characteristics may be stored in a database. Further, in addition to storing the image characteristics of the pre-defined segments of the first image, the first image may be stored at the database. Similarly, the image characteristics associated with the respective first images of the people in the pre-defined area are stored at the database.

FIG. 4a, FIG. 4b, and FIG. 4c represent a flowchart of a method for tracking the person in the pre-defined area, in accordance with the embodiment of the invention. As explained earlier in the figures, the person may be tracked in the pre-defined area based on one or more images, referred to as a first image (the primary image) and a second image (any subsequent image).

In an embodiment of the invention, the person may be moving in the pre-defined area, such as a shopping complex. An imaging device of the plurality of the imaging devices present at a pre-defined location of the pre-defined area may capture an image of the person. The image is further denoted as a variable Y. Thereafter, the image Y is received at 402.

At 404, the received image Y is divided into one or more pre-defined segments. The methodology of dividing the image into the one or more pre-defined segments has been explained in detail in conjunction with FIG. 3. Thereafter, at 406, one or more image characteristics are extracted from the one or more pre-defined segments of the received image Y. In an embodiment of the invention, an image characteristic is defined as features associated with a pre-defined image segment. For example, streaks or lines present at a particular position on the shoe segment. In another embodiment of the invention, the image characteristic may be defined as color of the non-shoe segment.

Subsequently at 408, in the embodiment of the invention, the corresponding image characteristics of the first image Xᵢ₌₁ (primary image) of a person are retrieved from the database. As explained earlier, the database may include first images Xᵢ corresponding to people present in the pre-defined area.

At 410, the image characteristics of the image Y are compared with the corresponding image characteristics of the retrieved first image X₁. The comparison is conducted between each unique image characteristic, i.e. the feature, of the image Y and the corresponding unique image characteristic, i.e. the feature, of the retrieved first image X₁. It may be appreciated by a person skilled in the art that there may be multiple features in an image that may be used to recognize a person. In an embodiment of the invention, the comparison conducted to recognize the person in the received image Y may be performed by using the SURF algorithm. The SURF algorithm compares “Euclidean distance” corresponding to the extracted features of the received image Y and the first image X₁ to ascertain the similarity between the corresponding images

To further elaborate, in an embodiment of the invention, each feature of the image is further denoted by its respective descriptor vector. Further, each descriptor vector is made of 128 dimensions. For example, in the shoe segment of the received image Y, the extracted feature may be a streak denoting a symbol such as “Adidas” present on the shoe. The streak is further denoted by its descriptor vector. Similarly, all the features identified in the received image Y and the retrieved first image X₁ are denoted by their respective descriptor vectors.

An Euclidean distance is then calculated between each of the identified features of the received image Y and the identified features of the first image X₁. For example, in case the received image Y has 6 features and the first image X₁ has 8 features. The Euclidean distance is calculated between each of the 6 identified features of the received image Y and the 8 identified features of the first image X₁. Hence, for each of the 6 features of the received image, there will be 8 corresponding Euclidean distances. Thereafter, the calculated 8 Euclidean distances corresponding to each feature of the received image Y is sorted to extract the minimum and the second minimum distances. In case, the ratio between the minimum and the second minimum distance is less than a pre-defined threshold then the corresponding feature of the received image Y is said to be a successful match to the first image X₁. Thus, the matched number of features is identified based on the number of the features of received image Y that have successfully matched with the features of the first image X1. In an exemplary embodiment of the invention, the pre-defined threshold is 0.6. Further, it may be apparent to a person skilled in the art that the pre-defined threshold may be increased to improve accuracy.

After which, the database is checked for any other stored first images Xᵢ at 412. In case, the database contains other first images Xᵢ (i<n), then the next first image Xᵢ₌₂ is selected at 414 and subsequently the corresponding image characteristics, i.e. the features, of the first image X₂ (primary image) are retrieved from the database. Thereafter, the methodology to calculate the Euclidean distances between each of the identified features of the received image Y to the features of the first image X₂ is repeated from step 410 and correspondingly matched number of features is identified. Similarly, all the stored first images Xᵢ (i<=n) are retrieved and the corresponding matched features are identified as described in 410. It may be apparent to any person skilled in the art that by repeating steps 408-414 for each compared pair of images, such as received image Y and first image X₁, received image Y and first image X₂ and so forth, the corresponding number of matched features is identified. After which, the first image Xₖ, (where 1<=k<=n) with the maximum matched features corresponding to the received image Y is selected at 416.

In another embodiment of the invention, a combination of a plurality of image processing algorithms may be used for comparing the images with respect to extracted features.

At 418, the matched features of the selected first image Xₖ are compared with a pre-determined threshold. In an exemplary embodiment of the invention, the pre-determined threshold is 10. If, the number of matched features is greater than the pre-determined threshold then the person is successfully recognized at 422. Subsequently, the person is located, at 424, based on a pre-defined location of the imaging device that captured the image Y.

It may be understood by a person skilled in the art that the received image Y corresponds to a second image, i.e., a subsequent image, of the person and thus the respective imaging device that captured the second image is referred to as the second imaging device, the third imaging device, the fourth imaging device, and so fourth.

In another embodiment of the invention, the image characteristic of the images may also be color of the non-shoe region. It may be apparent to a person skilled in the art that color of image Y may then be matched with each of the colors associated with each of the first images stored in the database and the first image Xₘ (1<=m<=n) that has the highest match of the color may be selected. Subsequently, the color of the selected image is also compared with a pre-determined color threshold for the effective match. Thereafter, based on the importance associated with each of the image characteristics, i.e. the feature and the color, one final matched image may be selected from the images obtained from the feature match process and the color match process.

On the contrary, if the number of matched features is less than the pre-defined threshold, it is the inferred at 420 that the received image is the first image Xₙ₊₁ of the person in the pre-defined area and is accordingly stored in the database at 420. Further, the received image Y is added in the database as a new first image Xᵢ (i=n+1). It may be apparent to any person skilled in the art that the newly added image may then be used later to identify the person associated with it.

Additionally, in various embodiments of the invention the stored first image Xᵢ of the person is deleted from the database after a pre-defined interval of time. The pre-defined interval may be as an hour, a day, a week, and so forth. Further, the pre-defined time may be set by a system administrator. In another embodiment of the invention the stored first images are deleted in a chronological order (first in first out). In yet another embodiment of the invention the stored first image Xᵢ of the person is deleted from the database if the person captured in the stored first image Xᵢ is not recognized for a pre-defined interval of time.

FIG. 5a and FIG. 5b represent a flowchart illustrating a method for tracking a person in a pre-defined area, in accordance with another embodiment of the invention. As explained earlier in the FIG. 2, FIG. 3 and FIG. 4, the person may be tracked in the pre-defined area based on one or more images, referred to as a first image and a second image.

At 502, the first image of a lower portion (portion below the waist) of the person is received. In an embodiment, the first image, i.e., the primary image of the person is captured by any imaging device, which is then referred to as a first imaging device, placed in the pre-defined area. This has been further explained in detail in conjunction with FIGS. 2, 3, and 4. Further, the first imaging device may be placed at a pre-defined location, for example “frozen foods section”, in the shopping complex. In another embodiment of the invention, the first image of the person is captured by the first imaging device that is placed at a fixed location in the pre-defined area as further described in FIG. 6.

At 504, the received first image of the person is tagged with an at least one identification tag of one or more identification tags. In an embodiment of the invention, the identification tag is a timestamp denoting the time at which the first image of the person was captured by the first imaging device. For example, in case the first image is captured at 10:00 AM by the first imaging device, the first image is tagged with a timestamp (denoting 10:00 AM) and is subsequently saved in a database at 506. It may be apparent to a person skilled in the art that various other identification tags can hence be attached to a received first image. The identification tag corresponding to an image in addition to the image processing algorithm facilitates efficient recognition of the person, further explained at 514.

Subsequently at 508, the second image of the lower portion of the person is received from a second imaging device. In an embodiment, the second image of the person is defined as any subsequent image of the primary image, captured by any imaging device placed in the pre-defined area. Further, the imaging device is placed at a pre-defined location, for example “frozen foods section”, “grocery section”, and “wines and spirits section”, in the shopping complex. For example, the person moves around the shopping complex and arrives at “grocery section”, the second image of the person is captured by the second imaging device located at the “grocery section”. Similar to the first image, the second image is also tagged with one or more identification tags at 510. Following the above example, the time-stamp (an identification tag) associated with the second image may be 10:04 AM at “grocery section”.

Thereafter at 512, the person is recognized based on his second image and first image. Further, recognizing the person based on the first image and the second image has been explained in detail in conjunction with FIG. 4. Subsequently, at 514, post the recognition of the person, the identification tags associated with the first image and the second image are analyzed to validate the recognition based on the first image and the second image.

In an embodiment of the invention, the analysis may include calculating the time difference between the time-stamp of the first image and the time-stamp of the second image to conclude whether the time difference between the two images satisfies the minimum time taken to move from the “frozen foods section” to the “grocery section”. Thus, it may be appreciated by a person skilled in the art that the time difference between the two images will facilitate efficient recognition of the person. Further, various time differences to travel between any two pre-defined locations in the pre-defined area may be pre-stored in the database. Following example, there may be a case that the person may take at least three minutes based on the pre-stored time difference to travel from “frozen foods section” to “grocery section”. Thus, following the above example, it is determined that the person took four minutes to travel from “frozen foods section” to “grocery section”, thereby validating the image comparison. After which, at 516, it is checked whether the analysis of the identification tags is successful. In case the analysis of the identification tags is successful, the person is identified at 518, based on the successful image comparison and tag comparison as explained earlier at 512 and 514, respectively. Thereafter, the person is located based on the pre-defined location, i.e., the “grocery section” of the second imaging device at 520.

Thereafter, on successfully locating the person at the pre-defined area at 520, a movement trend of the person is determined at 522. An exemplary movement trend may be listing the different pre-defined locations of the shopping complex that the person may have visited during his stay in the pre-defined area. In the above case for example, the person was at “frozen foods section” and “grocery section”. It may be apparent that the list of pre-defined areas may be further populated based on the number of subsequent images, which are captured by the imaging devices at different pre-defined locations, of the person.

Another exemplary analysis may be determining the time spent by the person in the pre-defined location. For example, the second image of the person may be captured at “frozen foods section” and after a time interval the subsequent image, i.e., the third image, of the person may also be captured at the “frozen foods section”. Thus, the analysis of the associated timestamps will facilitate the determination of the time spent by the person in the “frozen foods section”. It may be apparent to any person skilled in the art that above two exemplary scenarios are only for illustrative purposes and any other type of analysis may also be performed with the help of the timestamps and pre-defined locations of the associated images of the person.

It may be further appreciated by a person skilled in the art that the above embodiment has been explained in light of the time-stamp as an additional recognition parameter for identifying the person accurately. However, there may be other identification tags that may be used for identifying the person in addition to recognizing the person based on the image comparison.

FIG. 6a, FIG. 6b, and FIG. 6c represent a flowchart illustrating a method for tracking a person in a pre-defined area, in accordance with yet another embodiment of the invention. As explained earlier in conjunction with FIG. 2, FIG. 3 and FIG. 4, the person may be tracked in the pre-defined area based on one or more images, referred to as a first image and a second image.

At 602, at least one personal detail of the person is received at a first location in the pre-defined area. In an embodiment of the invention, the person is required to enter his/her mobile number of his/her communication device at the first location in the pre-defined area. Further, the first location may be an entry point of the shopping complex. It may be apparent to a person skilled in the art that various other personal details can also be saved with respect to the person, for example, an e-mail address, a residential address, a membership number, and a unique identification number. Moreover, there can be multiple entry points present in the shopping complex.

Subsequently, the first image of a lower portion (portion below the waist) of the person is received at the first location in the pre-defined area at 604. In an embodiment of the invention, the first image is captured by a first imaging device placed at the first location in the shopping complex. For example, there may be kiosks placed at various entry points in the shopping complex. As the person enters the shopping complex, he/she is prompted to enter his/her personal detail at the kiosk. In tandem while the person enters his/her personal detail at the kiosk, the first imaging device placed at the kiosk (the first location) captures the first image of the lower portion of the person. Thereafter, the first image is associated with the received personal detail of the person at 606.

At 608, the received first image of the person associated with the personal detail is further tagged with an at least one identification tag of one or more identification tags. As explained in FIG. 5 in accordance with an embodiment of the invention, the first image is tagged with an identification tag, where the identification tag is a time-stamp denoting the time at which the first image was captured. Additionally, the tagged first image along with the associated personal detail of the person is stored at a database at 610.

Thereafter at 612, the second image of the lower portion of the person is received from a second imaging device. In an embodiment of the invention, the second imaging device is any imaging device placed in the pre-defined area other than those placed at the entry point of the shopping complex (the imaging devices placed at the entry point captures the first image, i.e., the primary image of the person). Further, the second imaging device may be placed at a second location in the pre-defined area, for example “frozen foods section” and “grocery section” in the shopping complex. Similar to the first image, the second image is also tagged with one or more identification tags at 614. As explained in FIG. 5 and in correspondence with 608, the second image is tagged with an identification tag, where the identification tag is a time-stamp denoting the time at which the second image was captured.

Subsequently at 616, the person is recognized based on his second image and first image. Further, recognizing the person based on the first image and the second image has been explained in detail in conjunction with FIG. 4. After which, at 618, the identification tags associated with the first image and the second image are analyzed to validate the recognition based on the first image and the second image. As explained in FIG. 5 in an embodiment of the invention, the analysis may include calculating the time difference between time-stamp of the first image and the time-stamp of the second image to conclude whether the time difference between the two images satisfies the minimum time taken to move from the “frozen foods section” (entry point in the shopping complex) to “grocery section”. Furthermore, at 620, the person is identified based on the successful image comparison at 616 and tag comparison at 618. Thereafter, the person is located based on the pre-defined location, i.e. the grocery section of the second imaging device at 622.

After which, at 624, a message is sent to the person identified at the second location in the pre-defined area using the personal detail provided by the person at 602. In an embodiment of the invention, the message corresponding to the information of the identified present location of the person is sent to the communication device of the person. For example, the second imaging device placed at the “grocery section” in the shopping complex captures the second image of the person (a subsequent image of the person). Once the person is successfully identified with its respective first image as illustrated at 618-620, a message containing information related to the “grocery section” is sent to the communication device of the person using the personal details associated with the respective first image. The information related to the “grocery section” may be one of one or more promotions/advertisements available at the “grocery section”, at least one product location at the “grocery section” and other one or more product details available at the “grocery section”.

As explained earlier in conjunction with FIG. 5, a movement trend may be performed based on the time-stamps associated with the respective images of the person in the pre-defined area. Similarly, the movement trend may be performed each time the person visits the shopping store. Further, since the mobile number may remain same for the person, the movement trend associated with each visit may be accordingly attributed to the person. Thus, this will facilitate to understand the person's shopping behavior and may then accordingly be used by the shopping store for their further analysis.

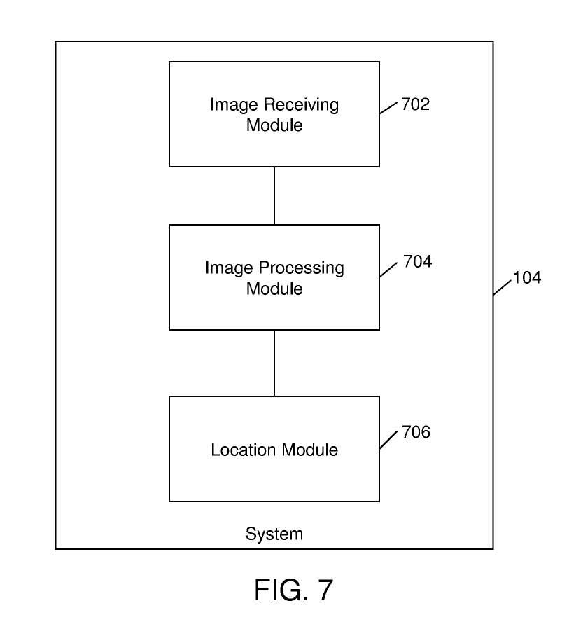

FIG. 7 is a block diagram of system 104 for tracking a person in a pre-defined area, in accordance with an embodiment of the invention. System 104 includes an image receiving module 702, an image processing module 704, and a location module 706. As illustrated in FIG. 1, system 104 interacts with plurality of imaging devices 102 to track the person in pre-defined area 100. Further, plurality of imaging devices 102 are placed in pre-defined area 100 at various pre-defined locations to capture one or more images of the person.

To further elaborate the working of system 104 in conjunction with FIG. 1, FIG. 2, FIG. 3, and FIG. 4, a first image of the person is received by image receiving module 702. As explained earlier, the first image of the lower portion (portion below the waist) of the person is the primary image captured by first imaging device 102a at a first location in pre-defined area 100. In an embodiment of the invention, pre-defined area 100 is a shopping complex. Thereafter, image receiving module 702 receives a second image of the person. As illustrated above, the second image is any other subsequent image of the lower portion of the person captured by second imaging device 102b at a second location. For example, first imaging device 102a may be at a “frozen foods section”; second imaging device 102b may be at a “grocery section”; and so forth.

After receiving the second image of the person, image receiving module 702 sends the received second image to image processing module 704 to process the received second image and the received first image to comprehend if the person captured in the second image is same as the person captured in the first image. The methodology to compare the images has been explained in conjunction with FIG. 3 and FIG. 4. On successful comparison between the second image and the first image, image processing module 704 recognizes the person captured in the second image.

Subsequently, location module 706 locates the recognized person based on the location of second imaging device. For example as illustrated above, the second image of the person is captured by second imaging device 102b placed at the “grocery section” in the shopping complex. Hence, once the person captured by second imaging device 102b is recognized, the present location of the person is identified as the “grocery section” in the shopping complex.

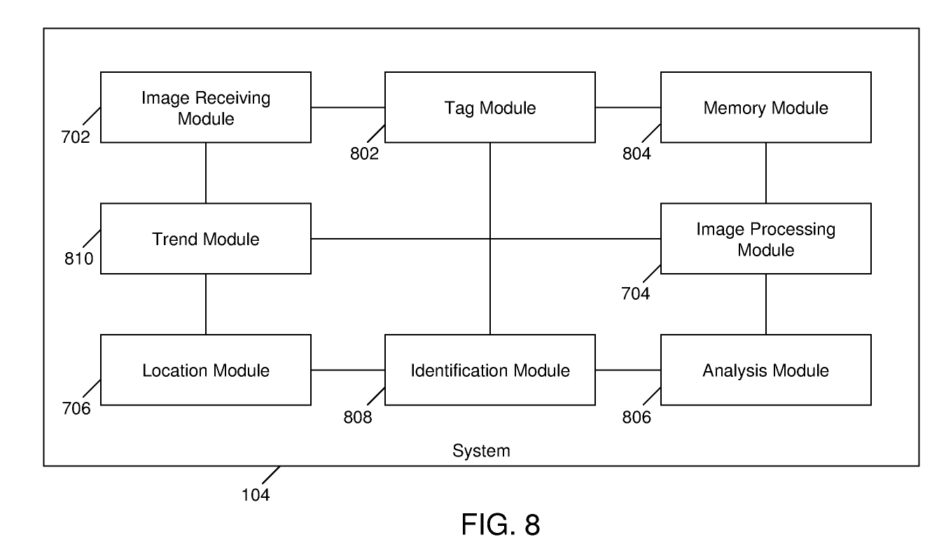

FIG. 8 is a block diagram of system 104 for tracking a person in a pre-defined area, in accordance with another embodiment of the invention. System 104 in addition to image receiving module 702, image processing module 704, and location module 706 further includes a tag module 802, a memory module 804, an analysis module 806, an identification module 808, and a trend module 810.

As described in FIG. 7, image receiving module 702 receives the first image and the second image of the person from plurality of imaging devices 102 respectively. Furthermore, on receiving the first image of the person, tag module 802 tags the received first image with an identification tag (as described in detail in FIG. 5), for example, a time-stamp denoting the time at which the first image was captured by first imaging device 102a. The tagged first image is further stored in memory module 804. Similarly, the received second image is also tagged with an identification tag (time-stamp) denoting the time the second image was captured (as explained above). In another embodiment of the invention, the tagged first image may be stored at a database of the shopping complex.

Image processing module 704 then processes the received second image and the first image retrieved from memory module 804. In an embodiment of the invention, image processing module 704 compares the second image and the first image based on one or more image processing algorithms. The methodology of comparison between the second image and the first image is explained elaborately in FIG. 4. After the successful comparison between the second image and the first image, analysis module 806 verifies the validity of comparison based on the analysis of the associated tags of the first image and the second image. Further, the analysis of the associated tags has been explained in detail in conjunction with FIG. 5.

Subsequently, identification module 808 identifies the person captured in the second image based on the positive result of both image processing module 704 and analysis module 806. After which, location module 706 locates the identified person based on the location of second imaging device 102b. Similarly, location module 706 locates the person at various pre-defined locations in the shopping complex based on the images that are captured at the corresponding pre-defined location. Further, these locations corresponding to the person are constantly stored in memory module 804.

Trend module 810 may then perform an analysis based on the various pre-defined locations that have been visited by the person. Further, trend module 810 may also perform the analysis based on the corresponding identification tags, such as time-stamps, of the images in addition to the pre-defined locations of the person. Hence, in an exemplary embodiment of the invention as explained in FIG. 5, trend module 810 would compute the time spent by the person being tracked at a particular location (store/aisle in a departmental store) in the shopping complex and the like. It may be appreciated by a person skilled in the art that various other data analytics can be processed by trend module 810.

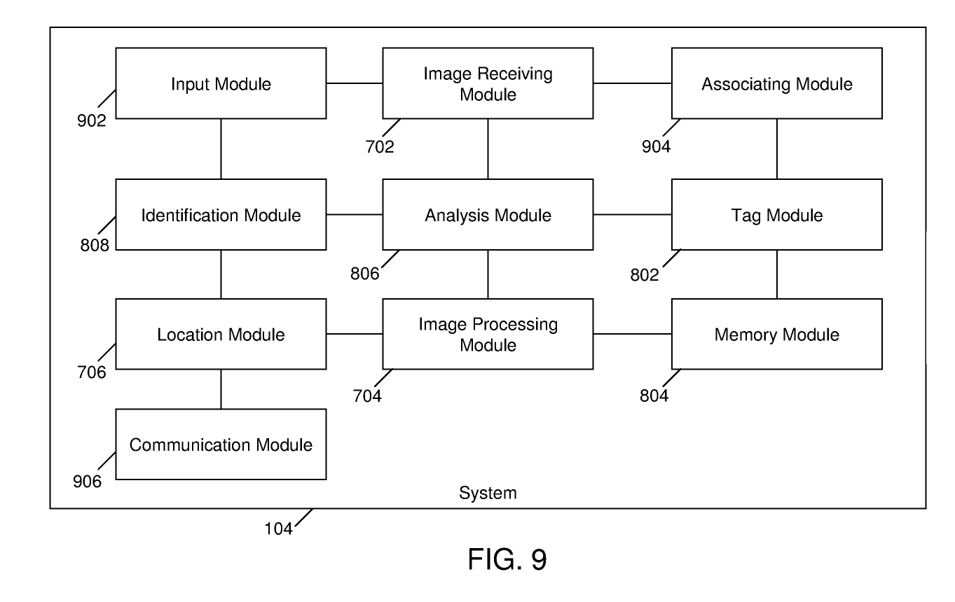

FIG. 9 is a block diagram of system 104 for tracking a person in a pre-defined area, in accordance with yet another embodiment of the invention. System 104 in addition to image receiving module 702, image processing module 704, location module 706, tag module 802, analysis module 806, identification module 808, and memory module 804 further includes an input module 902, an associating module 904, and a communication module 906.

Input module 902 receives the personal detail of the person. As explained in FIG. 6, the person is prompted at an entry point in a shopping complex to enter his/her personal detail. For example, when the person enters the shopping complex, a kiosk placed at the entry point prompts the person to enter his/her mobile number of a communication device. Thereafter, image receiving module 702 receives a first image of the person captured by first imaging device 102a as illustrated in FIG. 7. As elaborated earlier in conjunction with FIG. 6, first imaging device 102a is placed at the entry point (kiosk) of the shopping complex. Hence, as the person enters his/her personal detail at the entry point of the shopping complex, first imaging device 102a placed at the entry point captures the first image of the lower portion (below the waist) of the person.

Subsequently, associating module 904 associates the received personal detail of the person with the received first image of the person and sends it further to tag module 802. Thereafter, on receiving the first image of the person, tag module 802 tags the received first image with an identification tag (as described in details in FIG. 5 and FIG. 8). For example, a time-stamp denoting the time at which the first image was captured by first imaging device 102a. The tagged first image associated with the personal detail of the person is furthermore stored in memory module 804. Similarly, the received second image is also tagged with an identification tag (time-stamp) denoting the time the second image was captured (as explained above). The tagged first image retrieved from memory module 804 and the received tagged second image is thereafter sent to image processing module 704.

As explained in conjunction with FIG. 7 and FIG. 8, image processing module 704 processes the received second image and the first image retrieved from memory module 804. In an embodiment of the invention, image processing module 704 compares the second image and the first image based on one or more image processing algorithms. The methodology of comparison between the second image and the first image is explained elaborately in FIG. 4. After the successful image comparison between the second image and the first image, analysis module 806, as explained earlier in FIG. 8, verifies the validity of comparison based on the analysis of the associated tags of the first image and the second image.

Thereafter, in an embodiment of the invention, identification module 808 identifies the person captured in the second image based on the positive result of both image processing module 704 and analysis module 806 as explained in FIG. 5. In another embodiment of the invention, identification module 808 identifies the person based on the positive result of image processing module 704 only as explained in FIG. 4.

Thereafter, location module 706 locates the identified person based on the location of second imaging device 102b. Similarly, location module 706 locates the person at various pre-defined locations in the shopping complex based on the images that are subsequently captured at the corresponding pre-defined location. Further, these locations corresponding to the person are constantly stored in memory module 804 as illustrated in FIG. 7 and FIG. 8.

On successfully locating the person in the pre-defined area, communication module 906 further sends a message to a communication device of the person utilizing his/her personal details (the details which were inputted by the person at the kiosk). The message may contain information with respect to the present location of the person. For example, in case the person is identified at a “grocery section” in the shopping complex, communication module 906 may send a message, including information related to the “grocery section”. The information may be one of one or more promotions available at the “grocery section”, at least one product location at the “grocery section” and other one or more product details available at the “grocery section”.

In another embodiment of the invention, system 104 may include trend module 810 (not shown) to perform an analysis between the movement trends associated with each of the visits of the person to the shopping store. To further elaborate, the movement trend (explained in detail in conjunction with FIG. 8) associated with each visit may be attributed to the mobile number (the personal detail) of the person and accordingly be further analyzed to understand the areas, i.e. pre-defined areas, of his preference in the shopping complex.

The method, system and computer program product described above have a number of advantages. The invention as described above provides a cost effective and an efficient method for tracking a person. Further, the system is adaptable to interact with multiple imaging devices and thus is capable of being implemented in large facilities, such as shopping complexes and factories. Further, in contrast to the typical RFID tag system, the invention is not prone to considerable mechanical wear and tear which reduces the maintenance costs significantly. Moreover, since the invention utilizes image comparison based on the image of the lower portion of the person, it maintains the anonymity of the person and thereby eliminates the privacy issues of people in a predefined area. The system also provides a platform to send information based on the present location of the identified person to a communication device of the person. Such functionality helps the person to remotely receive promotional messages of the products available at the location where the person is present. In addition to the above mentioned advantages, the system also performs a trend analysis of the movement of the person in the pre-defined area.

The system for tracking a person in a pre-defined area, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for tracking a person in a pre-defined area. The computer program product includes a computer usable medium having a set program instructions comprising a program code for tracking a person in a pre-defined area. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A system for tracking a person in a pre-defined area, the pre-defined area comprising a plurality of imaging devices, each of the plurality of imaging devices being located at a corresponding pre-defined location, the system comprising:
a. an image receiving module configured for:
i. receiving a first image of a lower portion of the person, the first image being captured by a first imaging device at a first location in the pre-defined area;
ii. receiving a second image of the lower portion of the person, the second image being captured by a second imaging device at a second location in the pre-defined area;
b. an image processing module configured for recognizing the person at the second location by comparing the first image and the second image; and
c. a location module configured for locating the recognized person based on the second location.

2. The system according to claim 1 further comprising a memory module configured for storing at least one of the first image and at least one personal detail, the at least one personal detail being associated with the person.

3. The system according to claim 1 further comprising an input module configured for receiving at least one personal detail of the person at the first location.

4. The system according to claim 3 further comprising an associating module configured for associating the first image with the at least one personal detail at the first location, wherein the association facilitates defining the person in the pre-defined area.

5. The system according to claim 3 further comprising an identification module configured for identifying the person based on the at least one personal detail, the first image and the second image.

6. The system according to claim 3 further comprising a communication module configured for sending a message to a communication device of the person, the message being sent on the at least one personal detail, wherein the message comprises at least one information corresponding to the pre-defined location of the second imaging device.

7. The system according to claim 1, wherein the image processing module is further configured for dividing each of the first image and the second image into corresponding one or more pre-defined image segments.

8. The system according to claim 7, wherein the image processing module compares the first image and the second image by comparing at least one of the one or more pre-defined image segments associated with the first image with the corresponding at least one of one or more pre-defined image segments associated with the second image.

9. The system according to claim 8, wherein the image processing module compares at least one of the one or more pre-defined image segments associated with the first image with the corresponding at least one of one or more pre-defined image segments associated with the second image based on one or more image processing algorithms, each of the one or more image processing algorithms being associated with the corresponding one or more pre-defined image segments based on one or more image characteristics of the one or more pre-defined image segments.

10. The system according to claim 1 further comprising a tag module configured for associating each of the first image and the second image with corresponding one or more identification tags.

11. The system according to claim 10 further comprising an analysis module configured for comparing each of the one or more identification tags associated with the first image with the corresponding each of the one or more identification tags associated with the second image, wherein the comparison of the one or more identification tags associated with each of the first image and the second image facilitates identification of the person.

12. The system according to claim 1 further comprising a trend module configured for analyzing a movement trend of the person in the pre-defined area based on the location of the person.

13. The system according to claim 12, wherein the trend module is further configured for analyzing the movement trend of the person based on the corresponding pre-defined location and one or more identification tags associated with each of the first image and the second image.

14. The system according to claim 12, wherein the trend module is further configured to analyze the movement trend corresponding to each visit made by the person to the shopping store, each movement trend being associated to the person based on at least one personal detail, the at least one person detail being associated with the person.

15. A method for tracking a person in a pre-defined area, the pre-defined area comprising a plurality of imaging devices, each of the plurality of imaging devices being located at a corresponding pre-defined location, the method comprising:
a. receiving a first image of a lower portion of the person, the first image being captured by a first imaging device at a first location in the pre-defined area;
b. receiving a second image of the lower portion of the person, the second image being captured by a second imaging device at a second location in the pre-defined area;
c. recognizing the person at the second location based on the comparison between the first image and the second image; and
d. locating the recognized person based on the second location.

16. The method according to claim 15 further comprising receiving at least one personal detail of the person at the first location.

17. The method according to claim 16 further comprising associating the first image with the at least one personal detail of the person at the first location, wherein the association facilitates defining the person in the pre-defined area.

18. The method according to claim 16 further comprising identifying the person based on the at least one personal detail, the first image and the second image.

19. The method according to claim 16, wherein the at least one personal detail is at least one of a mobile number, an email address, a residential address, a membership number, and a unique identification number.

20. The method according to claim 16 further comprising sending a message to a communication device of the person, the message being sent on the at least one personal detail, wherein the message comprises at least one information corresponding to the pre-defined location of the second imaging device.

21. The method according to claim 20, wherein the at least one information is at least one of one or more promotions, at least one product location and one or more product details, the pre-defined area being a shopping complex.

22. The method according to claim 15 further comprising dividing each of the first image and the second image into corresponding one or more pre-defined image segments.

23. The method according to claim 22, wherein the comparison between the first image and the second image comprises comparing at least one of the one or more pre-defined image segments associated with the first image with the corresponding at least one of the one or more pre-defined image segments associated with the second image.

24. The method according to claim 23, wherein at least one of the one or more pre-defined image segments associated with the first image is compared with the corresponding at least one of one or more pre-defined image segments associated with the second image based on one or more image processing algorithms, each of the one or more image processing algorithms being associated with the corresponding one or more pre-defined image segments based on one or more image characteristics of the one or more pre-defined image segments.

25. The method according to claim 15 further comprising associating each of the first image and the second image with corresponding one or more identification tags.

26. The method according to claim 25, wherein recognizing the person at the second location further comprises:
a. analyzing the comparison between the first image and the second image based on the associated one or more identification tags; and
b. identifying the person based on the analyzed comparison.

27. The method according to claim 25, wherein at least one identification tag of the one or more identification tags is a time-stamp corresponding to each of the first image and the second image.

28. The method according to claim 15 further comprising analyzing a movement trend of the person in the pre-defined area based on the location of the person.

29. The method according to claim 28 further comprising analyzing the movement trend of the person in the pre-defined area based on the corresponding location and one or more identification tags associated with each of the first image and the second image.

30. The method according to claim 28 further comprising analyzing the movement trend corresponding to each visit made by the person to the shopping store, each movement trend being associated to the person based on at least one personal detail, the at least one person detail being associated with the person.

31. A computer program product for use with a computer, the computer program product comprising a set of instructions stored in a computer usable medium having a computer readable program code embodied therein for tracking a person in a pre-defined area, the pre-defined area comprising a plurality of imaging devices, each of the plurality of imaging devices being located at a corresponding pre-defined location, the computer readable program code performing:
a. receiving a first image of a lower portion of the person, the first image being captured by a first imaging device at a first location in the pre-defined area;
b. receiving a second image of the lower portion of the person, the second image being captured by a second imaging device at a second location in the pre-defined area;
c. recognizing the person at the second location based on the comparison between the first image and the second image; and
d. locating the recognized person based on the second location.

32. The computer program product of claim 31 further performing receiving at least one personal detail of the person at the first location.

33. The computer program product of claim 32 further performing associating the first image with the at least one personal detail of the person at the first location, wherein the association facilitates defining the person in the pre-defined area.

34. The computer program product of claim 32 further performing identifying the person based on the at least one personal detail, the first image and the second image.

35. The computer program product of claim 32 further performing sending a message to a communication device of the person, the message being sent on the at least one personal detail, wherein the message comprises at least one information corresponding to the pre-defined location of the second imaging device.

36. The computer program product of claim 31 further performing dividing each of the first image and the second image into corresponding one or more pre-defined image segments.

37. The computer program product of claim 36, wherein the computer readable program code further performs comparing at least one of the one or more pre-defined image segments associated with the first image with the corresponding at least one of one or more pre-defined image segments associated with the second image.

38. The computer program product of claim 37, wherein the computer readable program code further performs comparing at least one of the one or more pre-defined image segments associated with the first image with the corresponding at least one of one or more pre-defined image segments associated with the second image based on one or more image processing algorithms, each of the one or more image processing algorithms being associated with the corresponding one or more pre-defined image segments based on one or more image characteristics of the one or more pre-defined image segments.

39. The computer program product of claim 31 further performing associating each of the first image and the second image with corresponding one or more identification tags.

40. The computer program product of claim 39, wherein the computer readable program code further performs recognizing the person at the second location further performing:
a. analyzing the comparison between the first image and the second image based on the associated one or more identification tags; and
b. identifying the person based on the analyzed comparison.

41. The computer program product of claim 31 further performing analyzing a movement trend of the person in the pre-defined area based on the location of the person.

42. The computer program product of claim 41 further performing analyzing the movement trend of the person in the pre-defined area based on the corresponding location and one or more identification tags associated with each of the first image and the second image.

43. The computer program product of claim 41 further performing analyzing the movement trend corresponding to each visit made by the person to the shopping store, each movement trend being associated to the person based on at least one personal detail, the at least one person detail being associated with the person.
